(19) United States
(12) Patent Application Publication
(10) Pub. No.: US 2024/0087007 A1
(43) Pub. Date: Mar. 14, 2024

(54) INFORMATION PROCESSING DEVICE, INFORMATION PROCESSING METHOD, AND STORAGE MEDIUM

(71) Applicant: NS Solutions Corporation, Tokyo (JP)

(72) Inventors: Shohei KITAZATO, Tokyo (JP); Li YU, Tokyo (JP); Satoshi TOYOKURA, Tokyo (JP); Shoya MICHIMAE, Tokyo (JP); Tomoaki ISHII, Tokyo (JP); Kohei FUJINO, Tokyo (JP); l-Min CHIEN, Tokyo (JP); Yuta DATE, Tokyo (JP); Yoshifumi SATAKE, Tokyo (JP)

(21) Appl. No.: 18/463,684

(22) Filed: Sep. 8, 2023

(30) Foreign Application Priority Data
Sep. 13, 2022 (JP) 2022-145423

(51) Int. Cl. G06Q 40/02; G06Q 40/06

(52) U.S. Cl. CPC G06Q 40/02; G06Q 40/06

(57) ABSTRACT

An information processing device includes an associator, an extractor, and an outputter. The associator is configured to associate each of a series of pieces of history data related to at least any of deposits and withdrawals of a user with any of a plurality of behaviors related to an economic activity of the user. The extractor is configured to extract an inducement destination candidate according to behavioral characteristics of the user based on changes along a time series of each of the plurality of behaviors. The outputter is configured to output information indicating the extracted inducement destination candidate to a predetermined output destination.

### CROSS-REFERENCE TO RELATED APPLICATIONS

This application is based upon and claims the benefit of priority of the prior Japanese Patent Application No. 2022-145423, filed on Sep. 13, 2022, the entire contents of which are incorporated herein by reference.

### BACKGROUND OF THE INVENTION

### Field of the Invention

This disclosure relates to an information processing device, an information processing method, and a storage medium.

### Description of the Related Art

Various techniques for inducing a target user to purchase commodities or use services are investigated. As one example of such techniques, based on a commodity purchase history of a target user, a mechanism that recommends commodities that are likely to match hobbies and preferences of the user and encourages the user to purchase them is proposed. As another example, a mechanism that encourages the target user to purchase commodities by introducing what other commodities other users that have purchased an identical commodity are purchasing to the target user is proposed. Patent Document 1 discloses a technique that extracts and recommends only commodities in genres that match a preference of a user, based on commodity purchase history information and an internet surfing history of the user.

[Patent document 1] Japanese Laid-open Patent Publication No. 2001-229285

Meanwhile, while inducement destination candidates extracted from a commodity purchase history or service usage status are suitable for a preference trend of a user, they are not necessarily suitable for behavioral characteristics related to economic activities such as investment and savings, in some cases. From such a background, achievement of a mechanism that allows extraction of the inducement destination candidates that are more suitable for the behavioral characteristics related to the economic activities of the user is expected.

### SUMMARY OF THE INVENTION

In view of the above-described problem, an object of the present invention is to make it possible to extract the inducement destination candidates that are more suitable for the behavioral characteristics related to the economic activities of the user.

An information processing device according to one aspect of the invention includes an associator, an extractor, and an outputter. The associator is configured to associate each of a series of pieces of history data related to at least any of deposits and withdrawals of a user with any of a plurality of behaviors related to an economic activity of the user. The extractor is configured to extract an inducement destination candidate according to behavioral characteristics of the user based on changes along a time series of each of the plurality of behaviors. The outputter is configured to output information indicating the extracted inducement destination candidate to a predetermined output destination.

### BRIEF DESCRIPTION OF THE DRAWINGS

FIG. 1 is a drawing illustrating one example of a system configuration of an information processing system.

FIG. 2 a drawing illustrating one example of a hardware configuration of an information processing device.

FIG. 3 is a diagram for describing an outline of functions of the information processing system.

FIG. 4 is a diagram illustrating one example of a structure of a database of transaction data.

FIG. 5 is a diagram illustrating one example of the structure of the database of the transaction data.

FIG. 6 is a diagram illustrating one example of the structure of the database of the transaction data.

FIG. 7A to FIG. 7D are diagrams illustrating one example of determination results of behavioral characteristics of a user.

FIG. 8 is a diagram for describing one example of a management method of data of an investment behavior.

FIG. 9 is a function block diagram illustrating one example of a functional configuration of the information processing system.

FIG. 10A to FIG. 10F are diagrams illustrating one example of history data.

FIG. 11A and FIG. 11B are diagrams illustrating one example of a relationship between behavioral characteristics of a user and inducement destination candidates.

FIG. 12 is a diagram illustrating one example of the inducement destination candidates corresponding to the behavioral characteristics of the user.

FIG. 13A and FIG. 13B are flowcharts illustrating one example of processing of the information processing system.

FIG. 14A and FIG. 14B are diagrams illustrating one example of the relationship between the behavioral characteristics of the user and the inducement destination candidates.

FIG. 15 is a diagram illustrating one example of the relationship between the behavioral characteristics of the user and the inducement destination candidates.

FIG. 16 is a diagram illustrating one example of the relationship between the behavioral characteristics of the user and the inducement destination candidates.

### DETAILED DESCRIPTION OF THE PREFERRED EMBODIMENTS

The following describes preferred embodiments of this disclosure in detail below by referring to the attached drawings. In the specification and the drawings, by giving identical reference numerals to components having substantially identical functional configurations, duplex explanations are omitted.

<System Configuration>

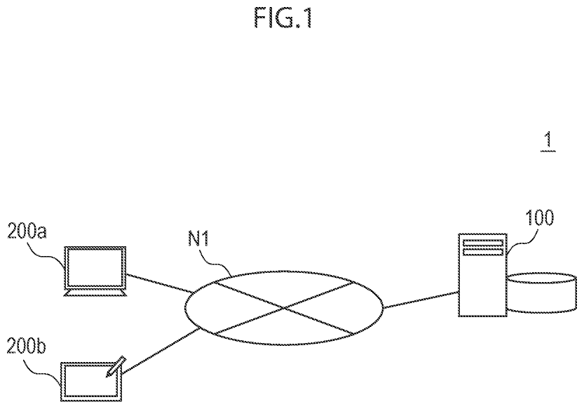

With reference to FIG. 1, one example of a system configuration of an information processing system according to the embodiment will be described. By using a history of procedures according to various instructions such as various kinds of instructions from a user and various kinds of instructions from other financial institutions, an information processing system 1 according to the embodiment determines behavioral characteristics of a target user and outputs inducement destination candidates such as commodities and services that are more suitable for the behavioral characteristics.

Specifically, by using a history of deposits and withdrawals associated with use of the financial institutions, a history of cashless payments using electronic money and the like, and a point history awarded associated with purchasing commodities and using services, and the like, the information processing system 1 determines (or estimates) the behavioral characteristics related to economic activities of the target user. Then, the information processing system 1 extracts and outputs the inducement destination candidates (for example, candidates of the commodities and services recommended to the user) as the commodities, the services, and the like more suitable for the behavioral characteristics of the target user.

In this embodiment, the configuration and the processing of the information processing system 1 will be described, focusing on a case of extracting and outputting financial products and financial education content more suitable for the behavioral characteristics as the inducement destination candidates by, particularly, determining the behavioral characteristics related to the economic activities of the user.

The information processing system 1 according to the embodiment includes an information processing device 100 and one or more terminal devices 200. In the example illustrated in FIG. 1, terminal devices 200a and 200b are disposed as the terminal device 200. The information processing device 100 and the terminal devices 200 are connected via a network N1 such that various kinds of pieces of information and data can be mutually transmitted and received.

The type of the network N1 that connects each of the devices that constitute the information processing system 1 is not particularly limited. As one specific example, the network N1 may be constituted by a Local Area Network (LAN), the Internet, dedicated lines, a Wide Area Network (WAN), or the like. The network N1 may be constituted by a wired network or may be constituted by a wireless network. The network N1 may include a plurality of networks, and as a part of the networks, the networks the type of which are different from other networks may be included. It is only necessary that the communication between the respective devices is logically established, and the physical configuration of the network N1 is not particularly limited. As one specific example, communication between the respective devices may be relayed by other communication devices or the like. In addition, a series of devices constituting the information processing system 1 need not necessarily be connected to a common network. That is, networks to which each of some devices and other devices are directly connected may be different as long as it is possible to establish communication between the devices through which information and data are transmitted and received.

Based on history information on the various kinds of processing and the various kinds of procedures according to the instructions of a user, the information processing device 100 determines the behavioral characteristics of the user and extracts and outputs the inducement destination candidates more suitable for the behavioral characteristics of the user. An output destination of information according to an extraction result of the inducement destination candidates is not particularly limited. As one specific example, by outputting the information according to the extraction result of the inducement destination candidates to the terminal device 200 via the network N1, the information processing device 100 may present the information to the user of the terminal device 200 via the terminal device 200. As another example, the information processing device 100 may output the information according to the extraction result of the inducement destination candidates to other server devices and the like that perform various kind of analyses or may store the information in a predetermined storage area. Details of a mechanism related to determination of the behavioral characteristics of a user and a mechanism related to extraction and output of the inducement destination candidates more suitable for the behavioral characteristics of the user will be described later.

The terminal device 200 plays a roll of an input interface for receiving input related to use of functions provided by the information processing device 100 and a role of an output interface related to presentation of various kinds of pieces of information to the user.

The configuration illustrated in FIG. 1 is merely one example, and the system configuration of the information processing system 1 is not necessarily limited as long as it is possible to achieve functions of the respective components of the information processing system 1, which will be described later. As one specific example, the information processing system 1 may be achieved as a so-called stand-alone environment in which the information processing device 100 and the terminal device 200 are integrally configured. As another example, a component corresponding to the information processing device 100 may be achieved by collaboration of a plurality of devices or may be achieved as a so-called network service.

<Hardware Configuration>

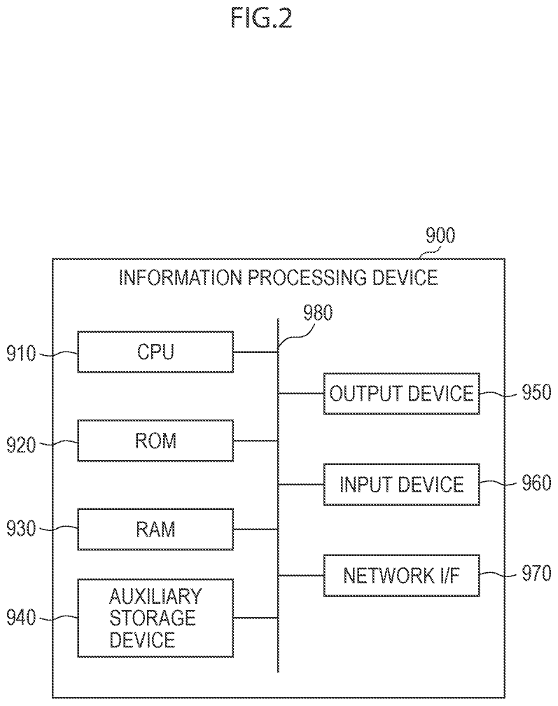

With reference to FIG. 2, one example of a hardware configuration of an information processing device 900 that can be applied as the information processing device 100 and the terminal device 200 in the information processing system 1 according to the embodiment will be described. As illustrated in FIG. 2, information processing device 900 according to the embodiment includes a Central Processing Unit (CPU) 910, a Read Only Memory (ROM) 920, and a Random Access Memory (RAM) 930. The information processing device 900 includes an auxiliary storage device 940 and a network I/F 970. The information processing device 900 may include at least one of an output device 950 and an input device 960. The CPU 910, the ROM 920, the RAM 930, the auxiliary storage device 940, the output device 950, the input device 960, and the network I/F 970 are mutually connected via a bus 980.

The CPU 910 is a central processing unit that controls various kinds of operations of the information processing device 900. For example, the CPU 910 may control the operation of the entire information processing device 900. The ROM 920 stores a control program, a boot program, and the like that can be executed by the CPU 910. The RAM 930 is a main storage memory of the CPU 910 and is used as a work area or a temporary storage area for deploying various kinds of programs.

The auxiliary storage device 940 stores various kinds of pieces of data and the various kinds of programs. The auxiliary storage device 940 is achieved by a storage device that can temporarily or persistently store various kinds of pieces of data, such as a non-volatile memory represented by a Hard Disk Drive (HDD) and a Solid-State Drive (SSD).

The output device 950 is a device that outputs various kinds of pieces of information and is used to present the various kinds of pieces of information to a user. For example, the output device 950 is achieved by a display device such as a display. In this case, the output device 950 present information to a user by displaying various kinds of pieces of display information. As another example, the output device 950 may be achieved by an acoustic output device that outputs sounds such as voice and electronic sounds. In this case, the output device 950 presents information to a user by outputting sounds such as voice or telegraph. A device that is applied as the output device 950 may be appropriately changed according to a medium used for presenting information to a user.

The input device 960 is used for receiving various kinds of instructions from a user. In the embodiment, the input device 960 includes input devices such as a computer mouse, a keyboard, and a touch panel. As another example, the input device 960 includes a sound collection device such as a microphone and may collect voice uttered by a user. In this case, various kinds of analysis processing such as acoustic analysis and natural language processing are performed on the collected voice, and thus, contents indicated by the voice is recognized as an instruction from a user. A device that is applied as the input device 960 may be appropriately changed according to a method of recognizing the instruction from the user. A plurality of types of devices may be applied as the input device 960.

The network I/F 970 is used for communication with an external device via a network. A device that is applied as the network I/F 970 may be appropriately changed according to a type of a communication path and an applied communication method.

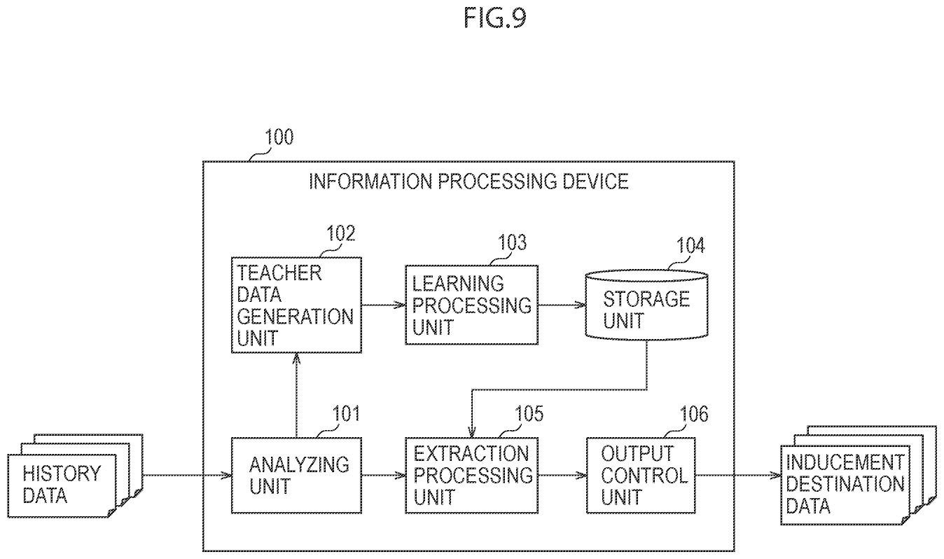

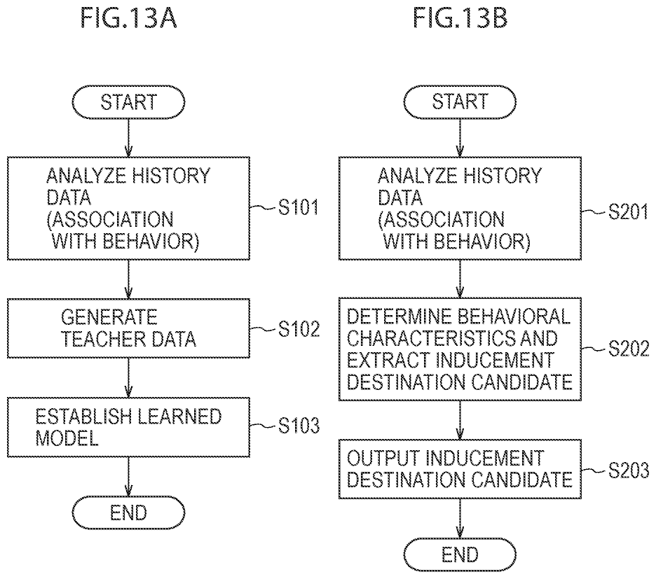

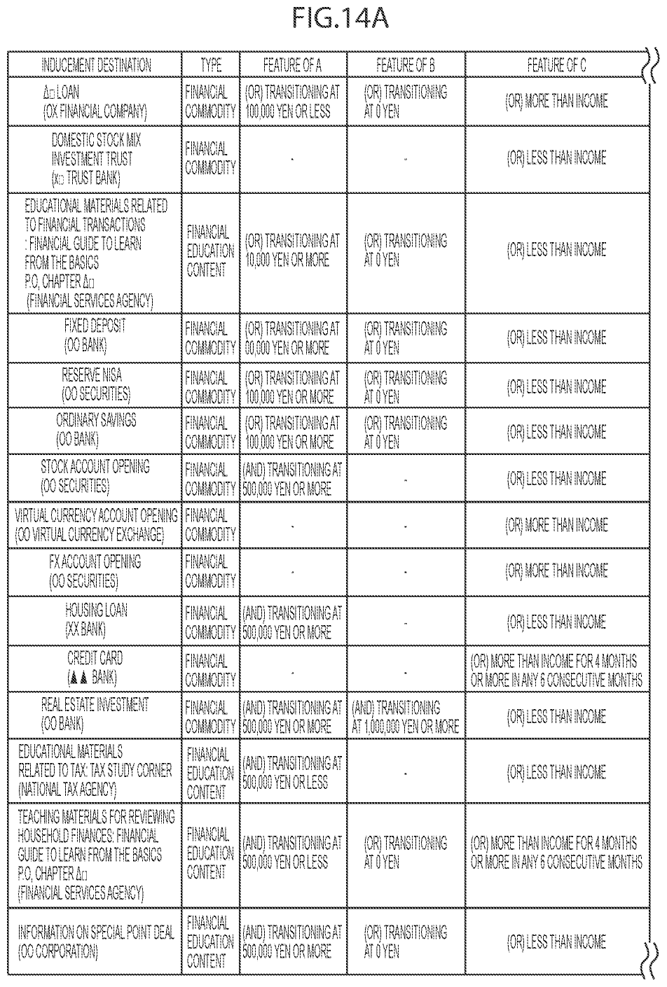

By the CPU 910 deploying the program stored in the ROM 920 or the auxiliary storage device 940 to the RAM 930 and executing the programs, the functional configuration of the information processing device 100 indicated in FIG. 9, the processing of the information processing device 100 that will be described with reference to FIGS. 13A and 13B, and the like are achieved.

<Technical Idea>

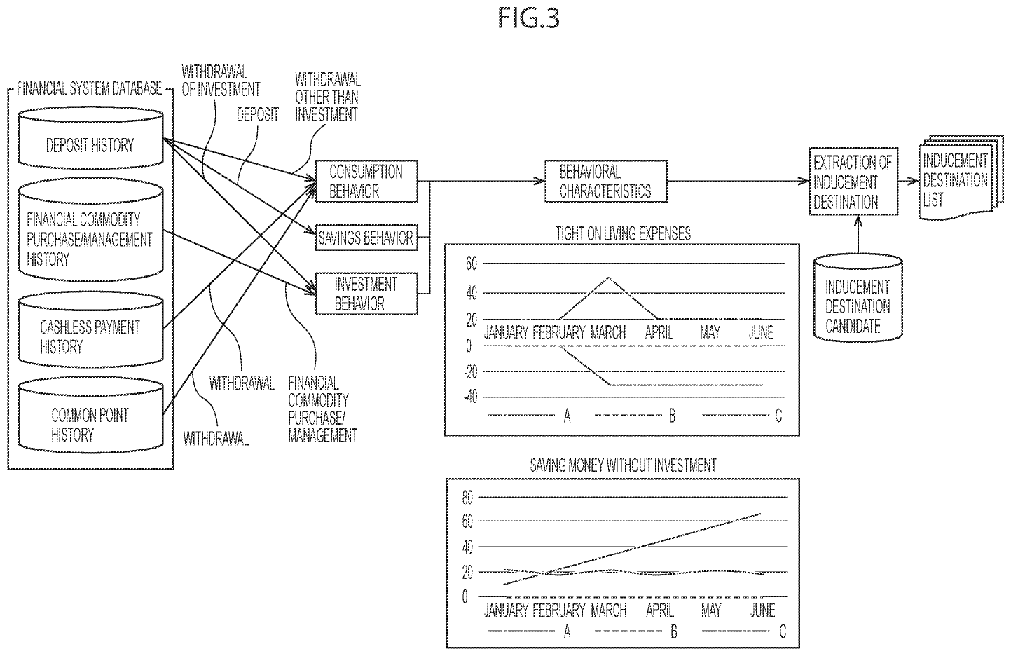

With reference to FIG. 3 to FIG. 8, an outline of the basic technical idea of the functions of the information processing system 1 according to the embodiment will be described below. First, with reference to FIG. 3, the outline of the functions of the information processing system 1 will be described.

The information processing system 1 according to the embodiment refers to transaction data related to at least any of the deposits and the withdrawals managed in a financial system database and associates each piece of transaction data with any of a plurality of behaviors related to the economic activities of the user.

In the financial system database, for example, history data of transactions generated in association with the processing of the deposits and the withdrawals is managed as a deposit history, a purchase history and a management history of financial products, a cashless payment history, a common point history, and the like. Hereinafter, transaction history data generated in association with deposit processing is also referred to as “history data related to the deposit,” and the transaction history data generated in association with withdrawal processing is also referred to as “history data related to the withdrawal.”

The transaction history data managed as the deposit history includes a deposit balance of a target account, the history data related to the deposits to the target account, and the history data related to the withdrawals from the account. In the information processing system 1 according to the embodiment, for the history data related to the withdrawals from the account, the history data related to the withdrawals for an investment purpose is distinguished from the history data related to the withdrawals corresponding to other applications different from investment.

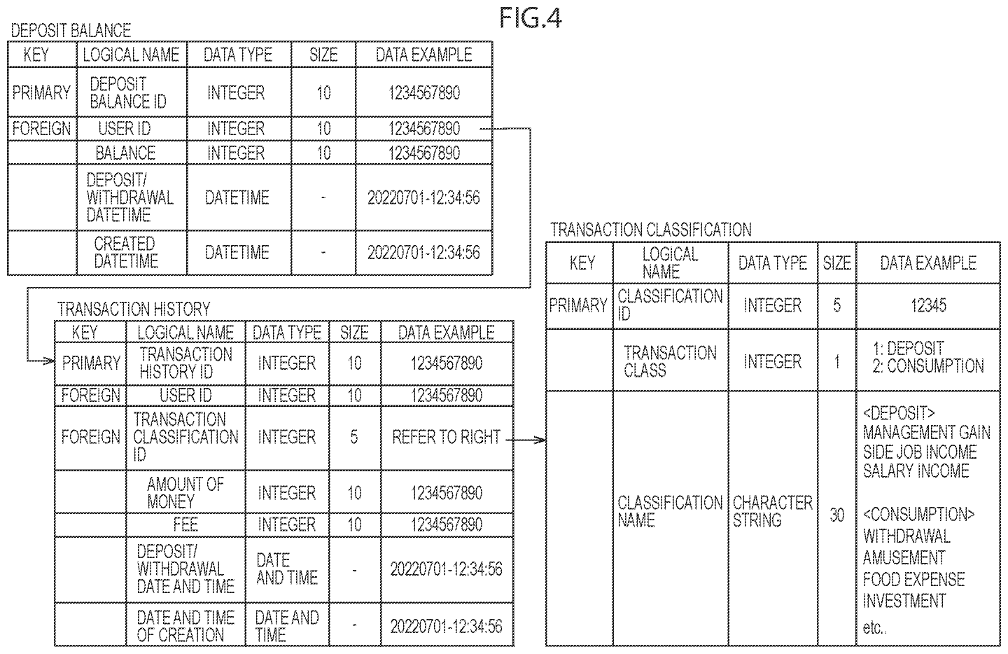

For example, FIG. 4 is a diagram illustrating one example of a structure of a database of transaction data managed as the deposit history. In the database illustrated in FIG. 4, a table for managing the transaction history (for example, an amount of money, a deposit/withdrawal datetime, and the like) related to the deposits or the withdrawals is linked to a table for managing the deposit balance that fluctuates in association with the deposits and the withdrawals to the target account. Each transaction related to the deposits and the withdrawals is classified according to the application of the transaction. This allows, for example, identifying whether the transaction history related to withdrawals corresponds to the history of the withdrawals (for example, the withdrawal for the investment purpose) corresponding to a predetermined application or the history of the withdrawals (for example, the withdrawals for the purpose other than investment) corresponding to other applications other than the application.

The history data related to withdrawals for the investment purpose corresponds to one example of “a second history data related to the withdrawals corresponding to a predetermined application,” and the history data related to the withdrawals corresponding to other applications different from the investment corresponds to one example of “a third history data related to the withdrawals corresponding to other applications other than a predetermined application.” The history data related to the deposits corresponds to one example of “a first history data.”

The transaction history data managed as the purchase history and the management history of the financial products includes the history data related to the withdrawals for the purposes of the purchase and the management of the financial products. The history data related to the withdrawals for the purposes of the purchase and the management of the financial products is classified into the history data (the second history data) related to the withdrawals for the investment purpose.

For example, FIG. 5 is a diagram illustrating one example of a structure of a database of the transaction data managed as the purchase history and the management history of the financial products. In the database illustrated FIG. 5, the information indicating the financial products to be managed and the information on the type of management (for example, order, possession, sale, purchase, reservation, or the like), the amount applied to the management, the datetime of trading, and the like are managed as the purchase history and the management history of the financial products.

The transaction history data managed as the cashless payment history includes the history data related to the withdrawals associated with the use of the cashless payment. The history data related to the withdrawals associated with the use of the cashless payment is classified into the history data (the third history data) related to the withdrawals corresponding to other applications different from the investment.

The transaction history data managed as the common point history includes the history data associated with the use of a so-called common point applied in a point program (point service) where a plurality of companies is participating to be available. This history data associated with the use of the common point is classified into the history data (the third history data) related to the withdrawals corresponding to other applications different from the investment.

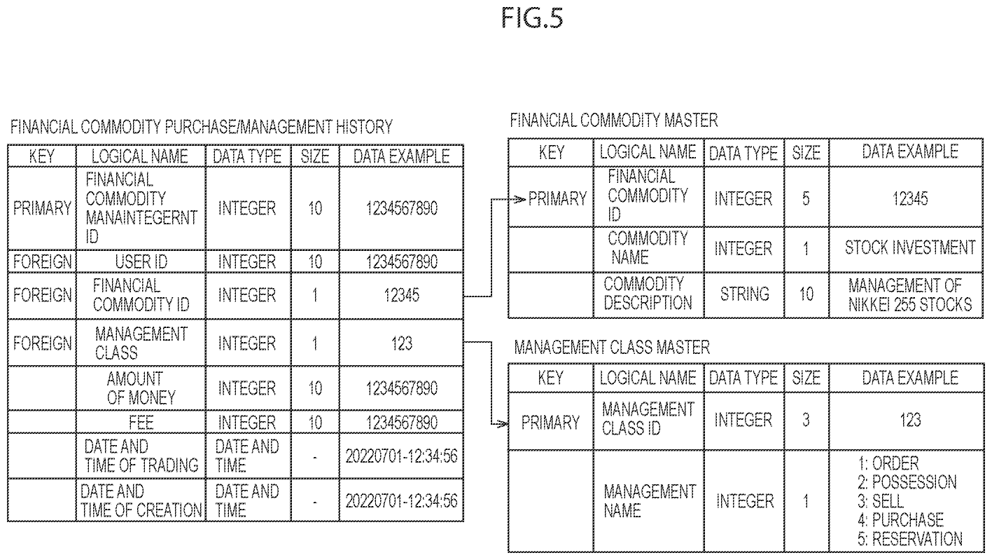

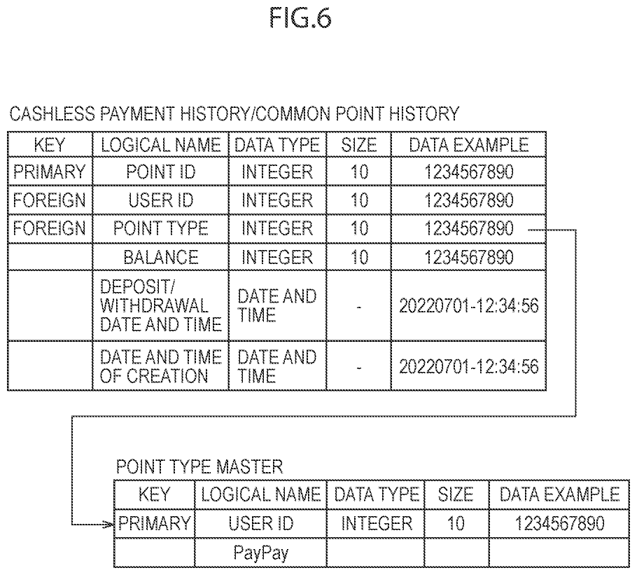

For example, FIG. 6 is a diagram illustrating one example of structure of a database of the transaction data managed as the cashless payment history and the common point history. In the database illustrated in FIG. 6, the information indicating the balance and the information on the type of the points, the deposit/withdrawal datetime, and the like are managed as a usage history.

As illustrated in FIG. 3, the information processing system 1 associates each piece of the history data related to the deposits and the withdrawals managed in the above-described financial database with any of a consumption behavior, a savings behavior, and an investment behavior, which are behaviors related to the economic activities of the user.

Specifically, the information processing system 1 associates the history data related to the deposits with “the savings behavior.” Namely, the history data related to the deposits managed as the deposit history is associated with the savings behavior.

Of the history data related to the withdrawals, the information processing system 1 associates the history data related to the withdrawals for the investment purpose with “the investment behavior.” Namely, the history data related to the withdrawals for the investment managed as the deposit history and the history data related to the withdrawals for the purpose of the purchase and the management of the financial products managed as the purchase history and the management history of the financial products are associated with the investment behavior.

Of the history data related to the withdrawals, the information processing system 1 associates the history data related to the withdrawals corresponding to other applications different from the investment with “the consumption behavior.” Namely, the history data related to the withdrawals corresponding to other applications different from the investment managed as the deposit history is associated with the consumption behavior.

The history data related to the withdrawals managed as the cashless payment history and the history data related to the withdrawals managed as the common point history are also associated with any of the investment behavior and the consumption behavior depending on whether it is the investment purpose or not. As one specific example, when the common point is transferred to the investment commodity or used for automatic allocation to the purchase of the financial products, the target history data is associated with the investment behavior.

Based on changes along the time series of each behavior (the savings behavior, the investment behavior, and the consumption behavior) with which the history data related to the deposits and the withdrawals is associated, the information processing system 1 determines the behavioral characteristics of the target user.

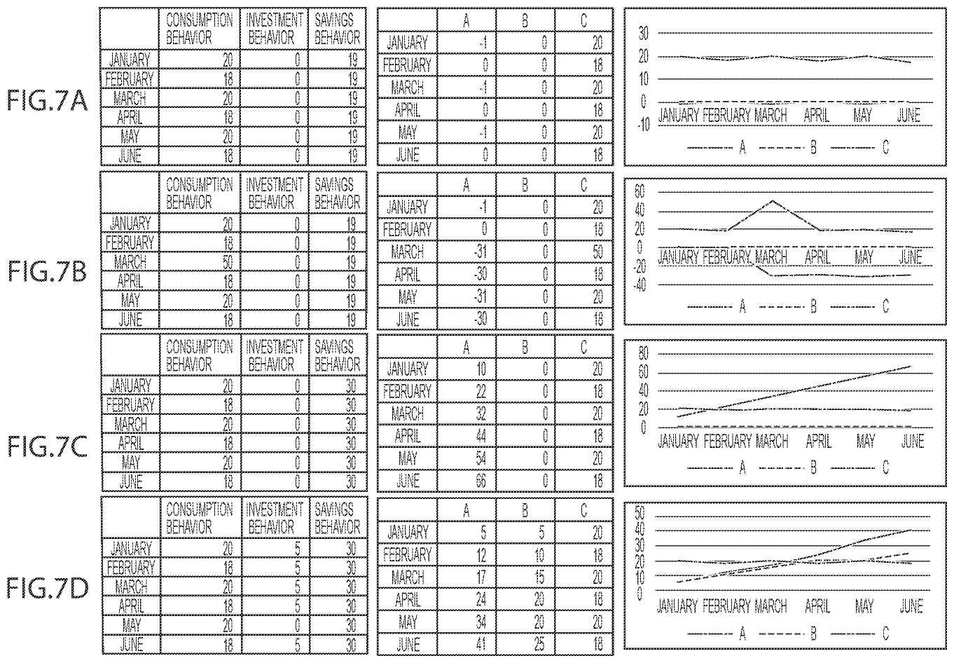

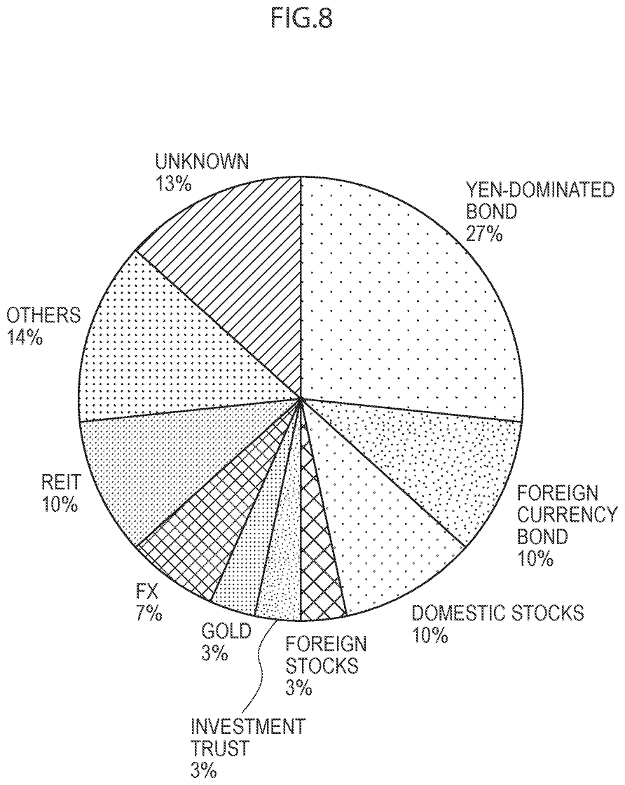

For example, FIGS. 7A to 7D are diagrams illustrating one example of a determination result of the behavioral characteristics based on the changes along the time series of a plurality of behaviors related to economic activities of a user. In the example illustrated in FIGS. 7A to 7D, four cases are shown as FIGS. 7A to 7D. In each of the cases indicated as FIGS. 7A to 7D, the table on the left indicates degree of the consumption behavior, the investment behavior, and the savings behavior for each month during a target period (a period from January to June) as numerical values. The table in the middle indicates one example of analysis results of the behavioral characteristics of the user based on the changes along the time series in each of the consumption behavior, the investment behavior, and the savings behavior, and the result in which this analysis result is plotted by month is indicated as a graph on the right.

Specifically, Data A is data obtained by subtracting an accumulated total value of the consumption behaviors from the accumulated total value of the savings behaviors, and then subtracting the accumulated total value of the investment behaviors. Data B is data indicating the accumulated total value of the investment behaviors for each month. Data C is data indicating the total value of the consumption behaviors for each month.

For example, in the samples exemplified as FIGS. 7A and 7B, both Data A and Data B are transitioning around zero. In such a case, since the savings and the consumption countervail with one another, and no investment is being made, it can be inferred that the target user is tight on living.

In the sample exemplified as FIG. 7C, while Data B is transitioning around zero, Data A rises linearly. In such a case, since the savings exceed the consumption and no investment is being made, it can be inferred that the target user is accumulating wealth with non-investment items such as ordinary deposits.

In the sample exemplified as FIG. 7D, both Data A and Data B rise linearly. In such a case, it can be seen that the savings exceed the consumption, and the investment is also being made. Since the savings exceed the consumption, it can be inferred that the target user can afford to live even after making the investment.

Regarding the data of the investment behavior, it is possible to distinguish how much investment has been made in what type of the financial commodity, in some cases. As one specific example, when the classification of the financial products to be managed is administratively managed as the history data related to the purchase and the management of the financial products, it is possible to distinguish how much the target investment behavior has invested in what type of financial commodity.

For example, FIG. 8 is a diagram illustrating one example of a case where the data of the investment behavior is classified and managed for each type of the financial products to be managed. In the example illustrated in FIG. 8, the data of the investment behavior is classified into “a yen-dominated bond,” “a foreign currency bond,” “domestic stocks,” “foreign stocks,” “an investment trust,” “gold,” “FX,” “REIT,” and “others,” which are the types of the financial products to be managed, and managed. In the example illustrated in FIG. 8, the data of the investment behavior for which the type of the financial product to be managed could not be identified is classified as “unknown.”

Namely, in the example illustrated in FIG. 8, the data of the investment behavior according to the history data related to the withdrawals corresponding to the application of the investment is classified into each of more detailed applications (for example, applications for each type of the financial products to be invested) classified from the applications, and managed.

While, in the example illustrated in FIG. 8, the financial products are mainly focused and described, it is also possible to classify and manage the financial education content and the like according to the type, content, and the like of the content.

Then, as illustrated in FIG. 3, the information processing system 1 extracts the inducement destination candidates (for example, the financial commodity, the financial education content, and the like) for the user according to the determination result of the behavioral characteristics of the target user and then outputs the information indicating the inducement destination candidates to a predetermined output destination.

A condition for extracting the inducement destination candidates according to the behavioral characteristics (in other words, a correspondence relationship between the behavioral characteristics and the inducement destination candidates) is established according to the history related to the use of each inducement destination candidate by each user and the behavioral characteristics of the user.

As one specific example, a plurality of users that have experience in financial activities (the purchase and the management of the financial products, use of the financial education content, or the like) for a certain period of time in the past are used as samples for evaluating the inducement destination candidates where they have experience in use. Then, for example, the inducement destination candidates to be evaluated and the data indicating the behavioral characteristics of the samples that have performed the evaluation are associated with one another and managed. With this, for example, since the inducement destination candidates that have received good evaluation are likely to similarly receive good evaluation from other users that exhibit behavioral characteristics similar to those of the samples that are the main subject of the evaluation, it can be more suitable inducement destination candidates for the other users. Namely, in order to be able to extract the inducement destination candidates more suitable for the target user according to the behavioral characteristics of the target user, it is only necessary to associate the inducement destination candidates to be evaluated and the data indicating the behavioral characteristics of the samples that have given the good evaluation to the inducement destination candidates with one another and manage them.

A learned model established based on so-called machine learning may be used to extract the inducement destination candidates according to the behavioral characteristics. In this case, for example, it is only necessary to establish the learned model by using teacher data in which the information indicating the inducement destination candidates (for example, the financial products, the financial education content, and the like) evaluated by the samples is attached to the data indicating the behavioral characteristics of the samples as a label (a correct answer label). With this, by inputting the data) indicating the behavioral characteristics of the target user (the data indicating the changes along the time series in the consumption behavior, the investment behavior, and the savings behavior in the learned model, it is possible to obtain the information indicating the inducement destination candidates more suitable for the behavioral characteristics, as an output.

As described above, the information processing system according to the embodiment extracts the inducement destination more suitable for the behavioral characteristics by analyzing at least any of pieces of the history data of the deposits and the withdrawals and determining the behavioral characteristics of the target user. This allows, for example, presenting the more suitable candidates (namely, the inducement destination candidates) of the commodities and the services to the target user. Then, in the following, the configuration and the processing of the information processing system according to the embodiment will be described in more detail.

<Functional Configuration>

With reference to FIG. 9, one example of the functional configuration of the information processing system 1 according to the embodiment will be described by particularly focusing on the configuration of the information processing device 100. In the following, the learned model established based on the machine learning is used for determining the behavioral characteristics of the target user and extracting the inducement destination candidates according to the behavioral characteristics.

The information processing device 100 includes an analyzing unit 101, a teacher data generation unit 102, a learning processing unit 103, a storage unit 104, an extraction processing unit 105, and an output control unit 106.

The analyzing unit 101 analyzes the history data related to at least any of the deposits and the withdrawals and associates the history data with any of the plurality of behaviors related to the economic activities of the user. In the embodiment, as described above, the analyzing unit 101 associates each piece of the history data related to the deposits and the withdrawals with any of the consumption behavior, the savings behavior, and the investment behavior.

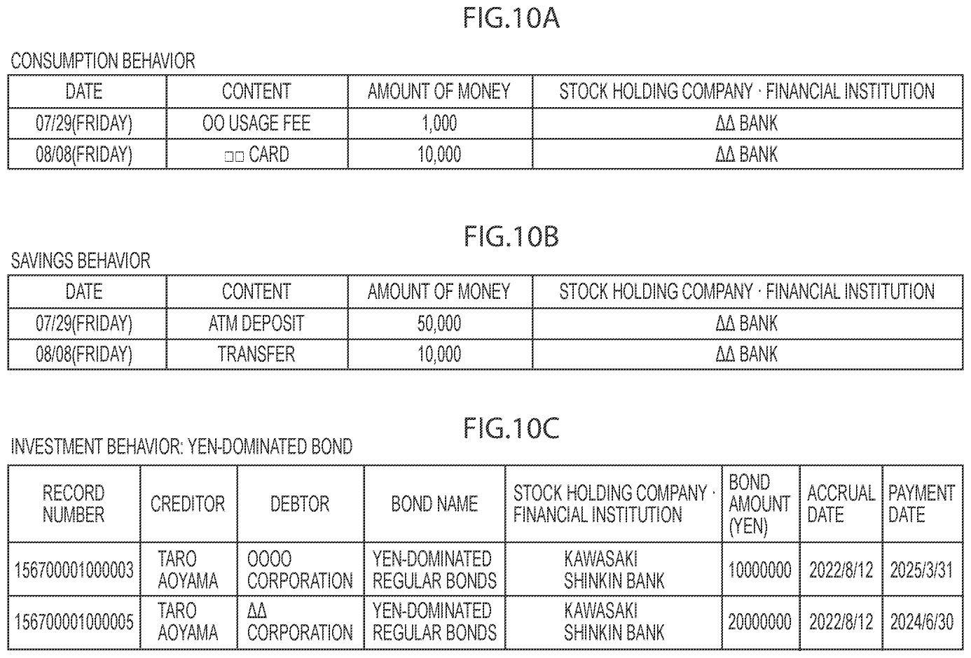

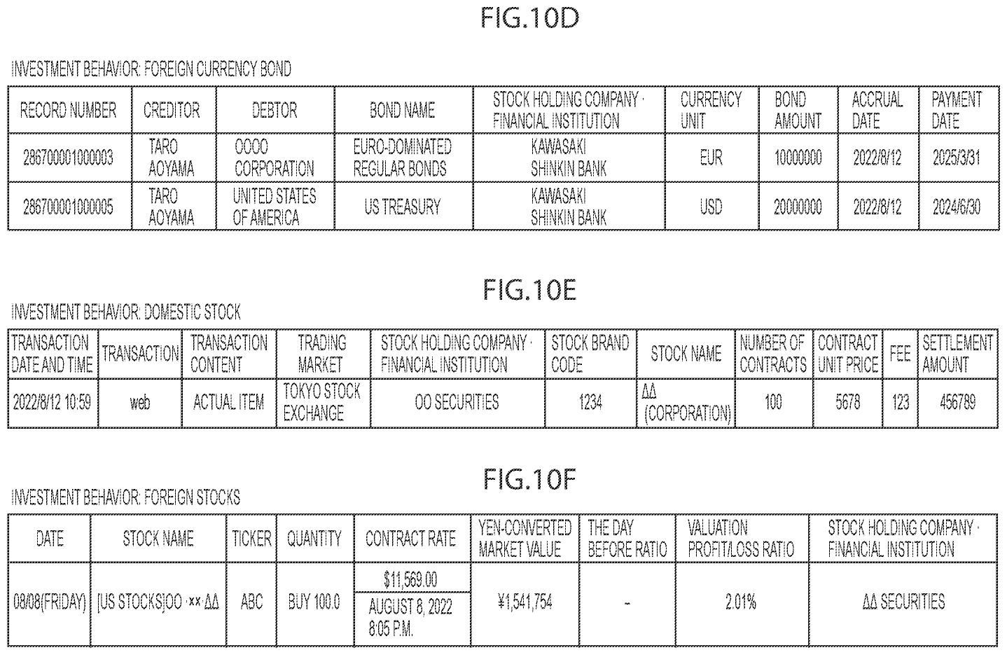

For example, FIG. 10A to FIG. 10F are diagrams illustrating one example of the history data.

Specifically, FIG. 10A illustrates one example of the history data related to deductions (namely, the withdrawals) from a predetermined account as one example of the history data associated with the consumption behavior.

FIG. 10B illustrates one example of the history data related to the deposits and transfers to a predetermined account as one example of the history data associated with the savings behavior.

In the examples illustrated in FIG. 10A and FIG. 10B, information indicating the date when the deposits or the withdrawals were made, the content of the procedure (any of the deposits and the withdrawals), the amount of money, and the like are recorded. Since, by using this information, it is possible to identify to which of the deposits and the withdrawals the target history data corresponds, it is possible to identify with which of the consumption behavior and the savings behavior the history date is to be associated. By using the above-described information, it is also possible to identify a timing at which the deposits or the withdrawals were made, namely, a timing at which the savings behaviors or the consumption behaviors were performed, the amount of money of the deposits or the withdrawals, and the like.

FIG. 10C to FIG. 10F illustrate one example of the history data associated with the investment behavior for each type of the financial products. Specifically, FIG. 10C illustrates one example of the history data related to the purchase and the management of yen-dominated bonds. FIG. 10D illustrates one example of the history data related to the purchase and the management of foreign currency bonds. FIG. 10E illustrates one example of the history data related to the purchase and the management of a domestic stock. FIG. 10F illustrates one example of the history data related to the purchase and the management of a foreign stock. FIG. 10C to FIG. 10F are merely examples, and the data structure of the history data may be appropriately changed according to the types of the target financial products, financial education content, or the like.

In the examples illustrated in FIG. 10C to FIG. 10F, the information indicating the date when the investment (purchase or management) was made, the amount of money managed, the target of the investment, and the like is recorded. By using these pieces of information, it is possible to associate the target history data with the investment behavior and identify the financial products, the financial education content, and the like, which are targets of the investment behavior. By using the above-described information, it is also possible to identify the timing at which the investment behavior was performed, the amount of money managed, and the like.

The teacher data generation unit 102 generates the teacher data used for establishing the learned model related to the extraction of the inducement destination according to the behavioral characteristics of the target user based on the analysis result of the history data of each sample by the analyzing unit 101. Specifically, for each sample (user), the teacher data generation unit 102 generates the teacher data by associating the information indicating the inducement destination candidates evaluated by the sample as the label with the data (in other words, the data indicating the behavioral characteristics) indicating the changes along the time series in each of the plurality of behaviors related to the economic activities of the sample. As described above, the teacher data generation unit 102 generates teacher data for each of the series of samples and output the teacher data to the learning processing unit 103.

The learning processing unit 103 obtains the teacher data generated for each of the series of samples from the teacher data generation unit 102 and establishes a model based on the machine learning using the teacher data. As described above, by inputting the data indicating the changes along the time series in each of the plurality of behaviors (namely, the consumption behavior, the savings behavior, and the investment behavior) related to the economic activities of the target user, the learned model that determines the behavioral characteristics of the user and outputs the inducement destination candidates according to the determination result of the behavioral characteristics is established. The data according to an establishment result of the learned model (namely, the data according to a learning result of the model) is stored in the storage unit 104. A storage area for holding various kinds of pieces of data of the storage unit 104 is schematically illustrated.

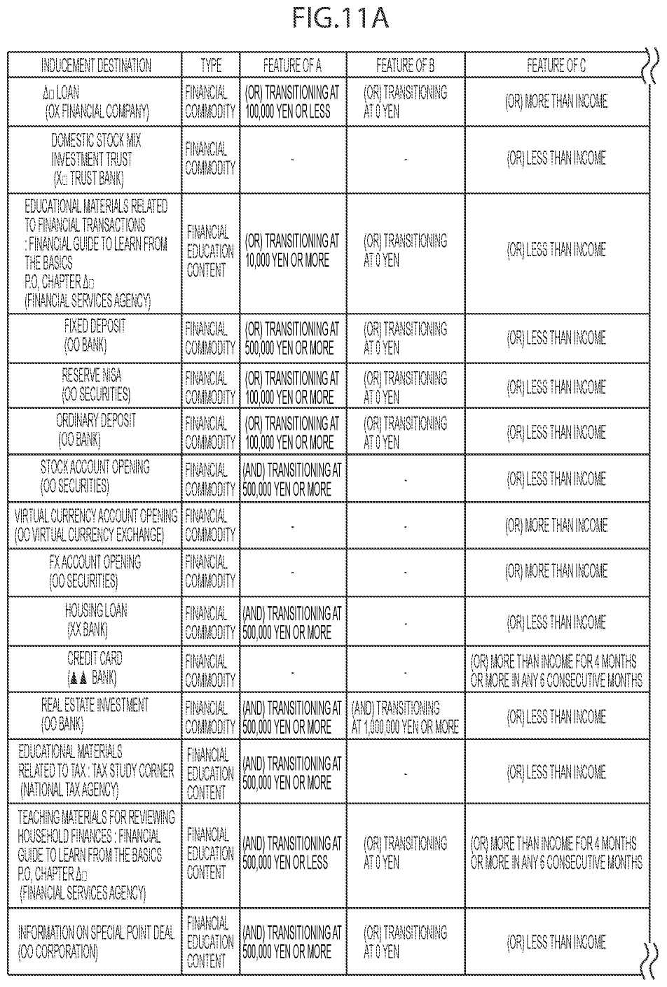

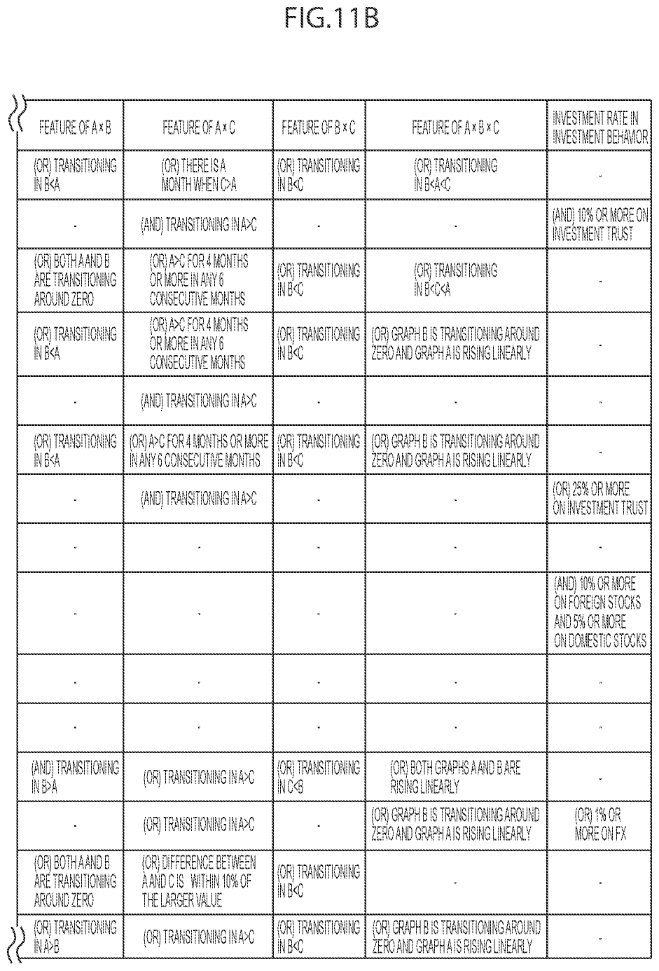

Here, with reference to FIG. 11A and FIG. 11B, one example of the learning result of the relationship between the behavioral characteristics of the user and the inducement destination candidates to be extracted will be described. In the example illustrated in FIG. 11A and FIG. 11B, the features indicated as Data A, Data B, and Data C correspond to Data A, Data B, and Data C described above with reference to FIGS. 7A to 7D. Specifically, In the example illustrated in FIG. 11A and FIG. 11B, the behavioral characteristics according to at least one feature of a series of features including the feature of each piece of Data A, Data B, and Data C and the features of combination of them and the inducement destination candidates used by the users (samples) that indicate the behavioral characteristics are associated with one another. In determining the behavioral characteristics of the user by the combination of the plurality of features, it may be set whether the relationship between each of the plurality of features and the other features is set to be an AND condition or an OR condition.

As one specific example, focusing on “reserve NISA (OO Securities),” which is the inducement destination candidate, it can be seen that the sample that satisfies the condition of “feature of A=transitioning at 100,000 yen or more,” “feature of B=transitioning at 0 yen,” or “feature of C=being less than income” and satisfies the condition of “feature of A×C=transitioning in A>C” is using the candidate.

As another example, focusing on “stock account opening (OO Securities),” which is the inducement destination candidate, it can be seen that the sample that satisfies the condition of “feature of C=being less than income” or “investment rate in investment behavior=25% or more on investment trust” and satisfies the conditions of “feature of A=trending at 500,000 yen or more” and “feature of A×C=transitioning in A>C” is using the candidate.

By using the characteristics as described above, for example, by matching the data indicating the behavioral characteristics of the target user with the data indicating the behavioral characteristics of the sample associated with each inducement destination candidate, it is possible to extract the inducement destination candidate used by the sample indicating the behavioral characteristics like or similar to those of the user.

Namely, by inputting the data (in other words, the data indicating the changes along time series in each of the plurality of behaviors related to the economic activity) indicating the behavioral characteristics of the target user with respect to the established learned model, it is possible to cause the learned model to output the inducement destination candidates used by the sample indicating substantially similar behavioral characteristics.

By using the above-described characteristics, the extraction processing unit 105 extracts the inducement destination candidates according to the behavioral characteristics of the target user (for example, the user that is the target of inducement to the inducement destination such as the financial products and the financial education content). Specifically, from the analyzing unit 101, the extraction processing unit 105 obtains the data indicating the changes along the time series in each of the plurality of behaviors (namely, the consumption behavior, the savings behavior, and the investment behavior) related to the economic activities of the user, according to the analysis result of the history data of the target user. By inputting the data obtained from the analyzing unit 101 into the learned model which is held in the storage unit 104, the extraction processing unit 105 causes the learned model to output the inducement destination candidates according to the behavioral characteristics of the target user. As described above, the extraction processing unit 105 extracts the inducement destination candidates according to the behavioral characteristics of the target user and outputs the data indicating the extracted inducement destination candidates to the output control unit 106.

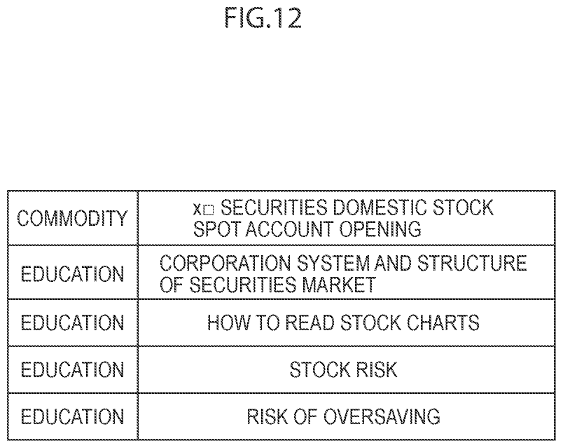

For example, FIG. 12 illustrates one example of the inducement destination candidates extracted according to the behavioral characteristics of a user. In the example illustrated in FIG. 12, the inducement destination candidates are not limited to only the financial commodity, and the financial education content are also included as an extraction target.

Typically, in purchasing of a financial commodity, the effect of obtaining more return and reducing loss is expected by sufficient education about risk and the like relative to the financial commodity. As for education, regarding investment activities where education is received from some contents, it is possible to provide more effective education by providing other education as a set to avoid the risks associated with the investment activities. According to the information processing system according to the embodiment, it is possible to provide a user with a set of the inducement destination candidates in which the above-described contents are systematically set, according to the behavioral characteristics of the user.

The output control unit 106 obtains data indicating the inducement destination candidates according to the behavioral characteristics of the target user from the extraction processing unit 105 and outputs the data to the predetermined output destination. As one specific example, by outputting the above-described data to an output device such as a display, the output control unit 106 may notify an operator (for example, the operator that operates the system) of the information indicating the inducement destination candidates according to the behavioral characteristics of the target user via the output device. As another example, the output control unit 106 may output the above-described data to an information processing device (for example, a server or the like) that performs various kinds of analyses. This allows the information processing device to use the extraction results of the inducement destination candidates according to the behavioral characteristics of the target user for various kinds of analyses.

The above-described configuration is merely one example, and the functional configuration of the information processing system 1 according to the embodiment is not necessarily limited to the example illustrated in FIG. 9. For example, the functional configuration of the information processing device 100 described with reference to FIG. 9 may be achieved by collaboration of a plurality of devices. As one specific example, functions of some components of a series of components of the information processing device 100 may be achieved by other devices. As another example, the processing load of at least some components of a series of components of the information processing device 100 may be dispersed among a plurality of devices. The functions of at least some components of a series of components of the information processing device 100 may be achieved as so-called network services represented by cloud services.

As described above, with reference to FIG. 9, one example of the functional configuration of the information processing system 1 according to the embodiment has been described with particular focus on the configuration of the information processing device 100.

<Processing>

With reference to FIGS. 13A and 13B, regarding one example of the processing of the information processing system according to the embodiment, focusing particularly on the processing of the information processing device 100, the processing related to establishment of the learned model and the processing related to extraction of the inducement destination using the learned model will be each described separately.

First, with reference to FIG. 13A, one example of the processing related to the establishment of the learned model will be described.

At S101, by setting a plurality of users that have experience in the financial activities for a certain period of time in the past as a sample, the analyzing unit 101 analyzes the history data related to at least any of the deposits and the withdrawals of the samples. Then, based on the result of the analysis, the analyzing unit 101 associates each piece of the history data with any of a plurality of behaviors related to the economic activities of the users, namely, the consumption behavior, the savings behavior, and the investment behavior.

At S102, the teacher data generation unit 102 generates the teacher data used for establishing the learned model related to extraction of the inducement destination candidates according to the behavioral characteristics of the target user, based on the analysis result of the history data of each sample by the analyzing unit 101 at S101. Specifically, the teacher data generation unit 102 generates the teacher data by associating the information indicating the inducement destination candidates evaluated by the sample as a label with respect to the data indicating the changes along the time series in each of the plurality of behaviors related to the economic activities of the samples, for each sample.

At S103, the learning processing unit 103 obtains the teacher data generated for each of a series of samples by the teacher data generation unit 102 at S102 and establishes a model based on the machine learning using the teacher data. With this, by inputting the data (in other words, the data indicating the changes along the time series in each of the plurality of behaviors related to the economic activities of the users) indicating the behavioral characteristics of the target user, the learned model outputting the inducement destination candidates more suitable for the behavioral characteristics is established. The data according to an establishment result of the learned model is stored in the storage unit 104.

Next, with reference to FIG. 13B, one example of the processing related to the extraction of the inducement destination using the above-described learned model will be described.

At S201, the analyzing unit 101 analyzes the history data related to at least any of the deposits and the withdrawals of the user to be the target of extraction of the inducement destination candidates. Then, based on the result of the analysis, the analyzing unit 101 associates each piece of the history data with any of the plurality of behaviors related to the economic activities of the users, namely, the consumption behavior, the savings behavior, and the investment behavior. With this, for example, by setting the history data for a specified period as target, it is possible to generate data indicating the changes along the time series in each of the consumption behavior, the savings behavior, and the investment behavior of the target users in the period.

At S202, the extraction processing unit 105 inputs the data according to the analysis result of the history data of the target users by the analyzing unit 101 at S201 to the learned model the data of which is held in the storage unit 104. With this, the behavioral characteristics of the target users are determined by the learned model and the information indicating the extraction result of the inducement destination candidates according to the determination result of the behavioral characteristics is output from the learned model. As described above, the extraction processing unit 105 extracts the inducement destination candidates according to the behavioral characteristics of the target users.

At S203, the output control unit 106 outputs the data that has been extracted by the extraction processing unit 105 at S202 and indicates the inducement destination candidates according to the behavioral characteristics of the target users, to the predetermined output destination. As one specific example, by outputting the above-described data to an output device such as a display, the output control unit 106 may notify an operator of the information indicating the inducement destination candidates according to the behavioral characteristics of the target users via the output device.

As described above, with reference to FIGS. 13A and 13B, regarding one example of the processing of the information processing system according to the embodiment, focusing particularly on the processing of the information processing device 100, the processing related to the establishment of the learned model and the processing related to the extraction of the inducement destination using the learned model are each described separately.

### MODIFICATION

The following describes modifications of the information processing system according to the embodiment.

### Modification 1

First, Modification 1 of the information processing system according to the embodiment will be described. As with a part of the financial products, some inducement destination candidates have age restrictions on their use. As one specific example, while there is no age restriction for opening a stock account, the age restrictions are individually set in some cases for each type of financial products, for example, the age restriction of 18 years old or older for opening a virtual currency account and the age restriction of 20 years old or older for opening a FX account. In view of such situations, in this modification, in extracting the inducement destination candidates according to the determination result of the behavioral characteristics of the target user, one example of a mechanism for controlling the extraction target in consideration of characteristics or attributes (for example, an age) of the user will be described.

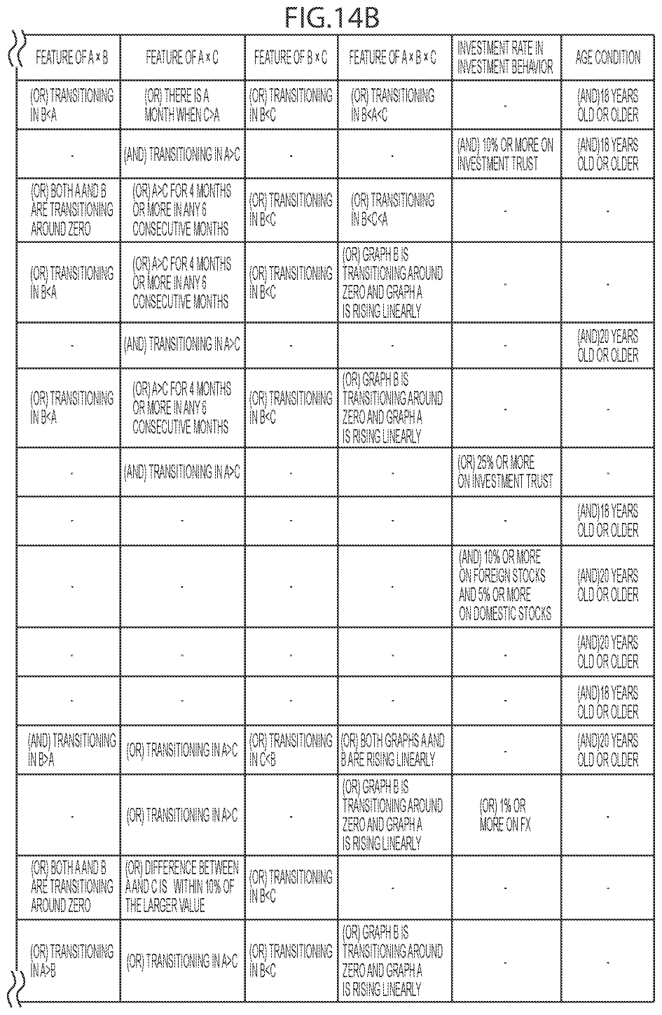

For example, FIG. 14A and FIG. 14B are diagrams illustrating one example of the learning result of the relationship between the behavioral characteristics of the user and the inducement destination candidates to be extracted, in the modification. In the example illustrated in FIG. 14A and FIG. 14B, the features indicated as Data A, Data B, and Data C correspond to Data A, Data B, and Data C described above with reference to FIGS. 7A to 7D, similarly to the example illustrated in FIG. 11A and FIG. 11B.

The example illustrated in FIG. 14A and FIG. 14B differs from the example illustrated in FIG. 11A and FIG. 11B in that an age condition is set. In the modification, in the extracting the inducement destination candidates for the target user, when a candidate with the age condition being set is included in a series of candidates, the extraction processing unit 105 collates the age condition with the age of the user to determine whether or not the candidate is to be extracted. This allows achieving filtering processing (namely, the filtering processing so as to restrict the extraction target) that excludes the inducement destination candidates where the age of the target user does not satisfy the condition from the extraction target.

As long as it is possible to control (for example, restriction) the inducement destination candidates to be extracted according to the age of the target user, the configuration and the method for that purpose are not particularly limited. As one specific example, the learned model may extract the inducement destination candidates according to the behavioral characteristics of the target user, and the filtering processing based on the age condition may be separately applied to a series of inducement destination candidates output from the learned model. As another example, when it is possible to establish a learned model such that restriction of extracting the inducement destination candidates in consideration of also the age condition is applied, the inducement destination candidates (namely, the inducement destination candidates in consideration of the age condition) to be finally output may be extracted by using the learned model.

While, in the above, one example of the case of controlling the inducement destination candidates to be extracted mainly according to the age condition has been described, control of the inducement destination candidates to be extracted may be performed in consideration of other characteristics or attributes of the user, not limited to only age. As one specific example, control (for example, restriction) of the inducement destination candidates to be extracted may be performed in consideration of gender, nationality, or the like of the target user.

As described above, with reference to FIG. 14A and FIG. 14B, Modification 1 of the information processing system according to the embodiment has been described.

### Modification 2

Next, Modification 2 of the information processing system according to the embodiment will be described. In the above-described embodiment, one example of the case of extracting the inducement destination candidates (namely, the inducement destination candidates that are desirable to induce the user) more suitable for the target user, according to the behavioral characteristics of the target user, has been described. Meanwhile, among the inducement destination candidates, a situation in which the inducement destination candidates that are undesirable to induce the user or the inducement destination candidates from which inducing the user should be restricted (eventually, the candidates that are desirable to prohibit inducement) are included can be assumed. Thus, in the modification, one example of a mechanism for extracting the inducement destination candidates that are undesirable to induce the user or the inducement destination candidates from which inducing the user should be restricted, according to the behavioral characteristics of the target user, will be described.

First, one example of the mechanism for extracting the inducement destination candidates that are undesirable to induce the user among the inducement destination candidates, according to the behavioral characteristics of the target user, will be described. In this case, first, similarly to the above-described embodiment, a plurality of users that have experience in financial activities for a certain period of time in the past are used as samples for evaluating the inducement destination candidates where they have experience of use. In addition, for example, it is only necessary to associate the inducement destination candidates to be evaluated and the data indicating the behavioral characteristics of the samples that have given a bad evaluation to the inducement destination candidates with one another and manage them. When a learned model is used for extracting the inducement destination candidates, it is only necessary to establish the learned model by using the teacher data where the information indicating the inducement destination candidates to which the samples have given a bad evaluation is attached to the data indicating the behavioral characteristics of the samples as a label.

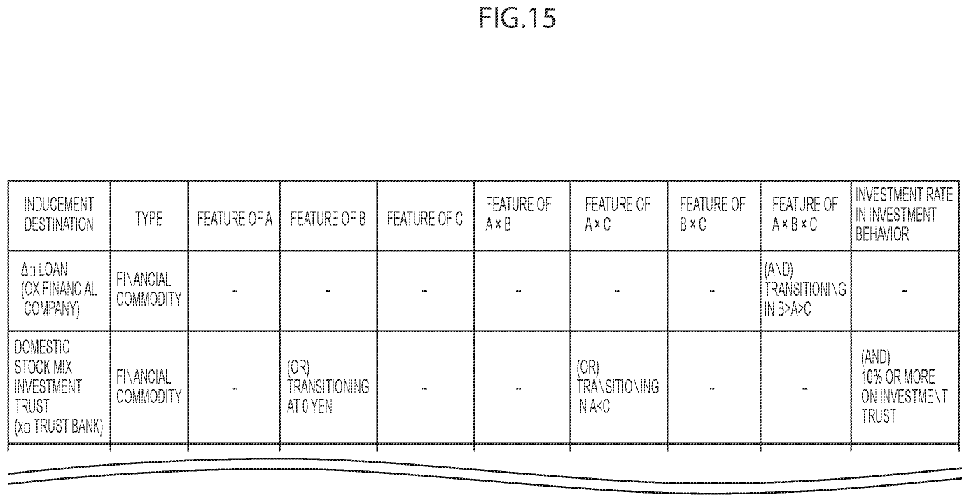

For example, FIG. 15 is a diagram illustrating one example of a learning result of the relationship between the behavioral characteristics of the user and the inducement destination candidates to be extracted, in the modification. In the example illustrated in FIG. 15, the features indicated as Data A, Data B, and Data C correspond to Data A, Data B, and Data C described above with reference to FIGS. 7A to 7D, similarly to the example illustrated in FIG. 11A and FIG. 11B.

As one specific example, focusing on “domestic stock mix investment trust (x□ trust bank)” that is the inducement destination candidate, it can be seen that the sample that satisfies the condition of “feature of B=transitioning at 0 yen” or “feature of A×C=transitioning in A<C” and satisfies the condition of “investment rate in investment behavior=10% or more on investment trust” is using the candidate. Namely, since the above-described inducement destination candidate is likely to receive bad evaluation from the user indicating the behavioral characteristics similar to the above, it can be the inducement destination candidate that is undesirable to induce the user.

As described above, by associating the inducement destination candidate to be extracted and the data indicating the behavioral characteristics of the samples that have given the bad evaluation to the inducement destination candidate with one another to manage them, it is possible to extract the inducement destination candidate that is undesirable to induce the user by inputting the data indicating the behavioral characteristics of the target user.

Next, one example of a mechanism for extracting the inducement destination candidates (eventually, the candidates that are desirable to prohibit inducement) from which inducing the user should be restricted among the inducement destination candidates, according to the behavioral characteristics of the target user, will be described.

In this case, plurality of users (a plurality of users listed on a so-called blacklist) whose accident information was recorded in a credit information bureaus (for example, CIC, JICC, KSC, and the like) for a certain period of time in the past are used as samples for selecting the inducement destination candidate where they have experience of use. In this case, of a series of the inducement destination candidates, predetermined types of financial products (for example, loan-based financial products, and the like) and financial education content may be excluded from selection targets. After that, for example, it is only necessary that the selected inducement destination candidates and the data indicating the behavioral characteristics of the samples that has selected the inducement destination candidates are associated with one another and managed. When the learned model is used for extracting the inducement destination candidates, it is only necessary that the learned model is established by using the teacher data in which the information indicating the inducement destination candidates that the samples have selected is attached to the data indicating the behavioral characteristics of the samples as a label.

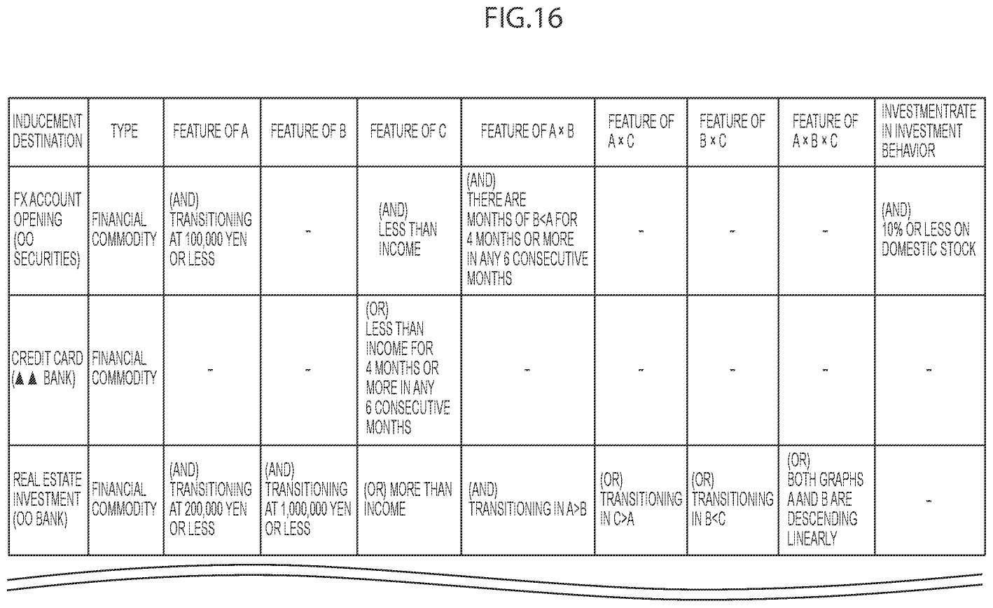

For example, FIG. 16 is a diagram illustrating another example of the learning result of the relationship between the behavioral characteristics of the user and the inducement destination candidates to be extracted, in this modification. In the example illustrated in FIG. 16, the features indicated as Data A, Data B, and Data C correspond to Data A, Data B, and Data C described above with reference to FIGS. 7A to 7D, similarly to the example illustrated in FIG. 11A and FIG. 11B.

As one specific example, focusing on “FX account temporary opening (OO Securities)” that is the inducement destination candidate, it can be seen that the sample that satisfies the conditions of “feature of A=transitioning at 100,000 yen or less,” “feature of C=being less than income,” “feature of A×B=there are months where B<A for 4 months or more in any 6 consecutive months” and “investment rate in investment behavior=10% or less on domestic stocks” has selected the candidate. Namely, since, regarding the above-described inducement destination candidate, an accident is likely to occur when users indicating behavioral characteristics similar to those described above use the candidate, the candidate can be the inducement destination candidate from which inducing the user should be restricted.

As described above, by associating the inducement destination candidate to be evaluated and the data indicating the behavioral characteristics of the sample that has selected the inducement destination candidate of the samples to which the accident information has been recorded with one another and managing them, it is possible to extract the inducement destination candidate from which inducing the user should be restricted by inputting the data indicating the behavioral characteristics of the target user.

As described above, by learning of the relationship between each of the inducement destination candidates and the behavioral characteristics of the users according to the conditions related to the relationship between the users and the inducement destination candidates, it is possible to control the inducement destination candidates to be extracted according to usage purposes of the extraction results.

As described above, with reference to FIG. 15 and FIG. 16, Modification 2 of the information processing system according to the embodiment has been described.

### CONCLUSION

As described above, in the information processing system according to the embodiment, the information processing device associates each of a series of pieces of history data related to at least any of the deposits and the withdrawals with any of the plurality of behaviors related to the economic activities of the user. The information processing device extracts the inducement destination candidates according to the behavioral characteristics of the above-described user based on the changes along the time series of each of the above-described plurality of behaviors. After that, the information processing device outputs the information indicating the extracted inducement destination candidates to the predetermined output destination.

By the configuration as described above, it is possible to present the inducement destination (for example, the candidates that are desirable to induce the user, the candidates that are undesirable to induce the user, the candidates from which inducing the user should be restricted, and the like) that are more suitable for the behavioral characteristics of the user to the target user.

The present embodiment can be realized when a computer executes a program. Further, a computer-readable recording medium recording the above-described program, and a computer program product such as the above-described program, can also be applied as embodiments of the present invention. As the recording medium, it is possible to use, for example, a flexible disk, a hard disk, an optical disk, a magneto-optic disk, a CD-ROM, a magnetic tape, a nonvolatile memory card, a ROM, and the like.

Note that following configurations also belong to the technical scope of the present disclosure.

(1) An information processing device including:
an associator configured to associate each of a series of pieces of history data related to at least any of deposits and withdrawals of a user with any of a plurality of behaviors related to an economic activity of the user;
an extractor configured to extract an inducement destination candidate according to behavioral characteristics of the user based on changes along a time series of each of the plurality of behaviors; and an outputter configured to output information indicating the extracted inducement destination candidate to a predetermined output destination.
   (2) The information processing device according to (1), in which
the associator associates a first history data related to the deposits, a second history data related to the withdrawals corresponding to a predetermined application, a third history data related to the withdrawals corresponding to another application other than the application with mutually different behaviors.
   (3) The information processing device according to (2), in which
the extractor extracts the inducement destination candidate according to the behavioral characteristics of the user in consideration of a more detail application classified from the predetermined application.
   (4) The information processing device according to (3), in which
the predetermined application includes an application of at least any of an investment into a financial product and use of a financial education content,
the extractor extracts the inducement destination candidate of at least any of the financial product and the financial education content as the inducement destination candidate related to the behavioral characteristics of the user.
   (5) The information processing device according to any one of (1) to (4), in which
the extractor extracts the inducement destination candidate according to the behavioral characteristics of the user in consideration of conditions related to relationship between the user and the inducement destination candidate.
   (6) The information processing device according to (5), in which
the extractor, as the inducement destination candidate according to the behavioral characteristics of the user, extracts the candidate of at least any of a candidate that is desirable to induce the user, a candidate that is undesirable to induce the user, and a candidate from which inducing the user should be restricted, according to the conditions related to the relationship between the user and the inducement destination candidate.
   (7) The information processing device according to any one of (1) to (6), in which
the extractor extracts the inducement destination candidate according to the behavioral characteristics of the user in consideration of characteristics of the target user.
   (8) The information processing device according to (7), in which
the extractor restricts the inducement destination candidate to be extracted according to an age of the user.
   (9) The information processing device according to any one of (1) to (8), in which
the extractor extracts the inducement destination candidate according to the behavioral characteristics of the user, by inputting data indicating changes along a time series in each of a plurality of behaviors associated with each of the series of pieces of the history data,
to a learned model established based on supervised learning using teacher data where information indicating the inducement destination candidate used by a user as a subject of the plurality of behaviors is associated with the data indicating the changes along the time series in each of the plurality of behaviors, as a correct label.
   (10) The information processing device according to (9), in which
the extractor extracts an inducement destination candidate according to the behavioral characteristics of the user where predetermined characteristics are considered regarding relationship with a target user, by inputting data indicating changes along a time series in each of a plurality of behaviors associated with each of the series of pieces of the history data,
to the learned model that corresponds to the predetermined characteristic and is established based on supervised machine learning using teacher data where information indicating the inducement destination candidate used by the user is associated as a correct label with the data indicating the changes along the time series in each of the plurality of behaviors of the user exhibiting the predetermined characteristics regarding the relationship with the inducement destination candidate.
   (11) An information processing method executed by an information processing device, including:
associating each of a series of pieces of history data related to at least any of deposits and withdrawals of a user with any of a plurality of behaviors related to an economic activity of the user;
extracting an inducement destination candidate according to behavioral characteristics of the user based on changes along a time series of each of the plurality of behaviors; and
outputting information indicating the extracted inducement destination candidate to a predetermined output destination.
   (12) A computer readable storage medium storing a program for causing a computer to execute:
associating each of a series of pieces of history data related to at least any of deposits and withdrawals of a user with any of a plurality of behaviors related to an economic activity of the user;
extracting an inducement destination candidate according to behavioral characteristics of the user based on changes along a time series of each of the plurality of behaviors; and
outputting information indicating the extracted inducement destination candidate to a predetermined output destination.

According to the present invention, it becomes possible to extract the inducement destination candidates that are more suitable for the behavioral characteristics related to the economic activities of the user.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

What is claimed is:

1. An information processing device comprising:
an associator configured to associate each of a series of pieces of history data related to at least any of deposits and withdrawals of a user with any of a plurality of behaviors related to an economic activity of the user;
an extractor configured to extract an inducement destination candidate according to behavioral characteristics of the user based on changes along a time series of each of the plurality of behaviors; and
an outputter configured to output information indicating the extracted inducement destination candidate to a predetermined output destination.

2. The information processing device according to claim 1, wherein
the associator associates a first history data related to the deposits, a second history data related to the withdrawals corresponding to a predetermined application, a third history data related to the withdrawals corresponding to another application other than the application with mutually different behaviors.

3. The information processing device according to claim 2, wherein
the extractor extracts the inducement destination candidate according to the behavioral characteristics of the user in consideration of a more detail application classified from the predetermined application.

4. The information processing device according to claim 3, wherein
the predetermined application includes an application of at least any of an investment into a financial product and use of a financial education content,
the extractor extracts the inducement destination candidate of at least any of the financial product and the financial education content as the inducement destination candidate related to the behavioral characteristics of the user.

5. The information processing device according to claim 1, wherein
the extractor extracts the inducement destination candidate according to the behavioral characteristics of the user in consideration of conditions related to relationship between the user and the inducement destination candidate.

6. The information processing device according to claim 5, wherein
the extractor, as the inducement destination candidate according to the behavioral characteristics of the user, extracts the candidate of at least any of a candidate that is desirable to induce the user, a candidate that is undesirable to induce the user, and a candidate from which inducing the user should be restricted, according to the conditions related to the relationship between the user and the inducement destination candidate.

7. The information processing device according to claim 1, wherein
the extractor extracts the inducement destination candidate according to the behavioral characteristics of the user in consideration of characteristics of the target user.

8. The information processing device according to claim 7, wherein
the extractor restricts the inducement destination candidate to be extracted according to an age of the user.

9. The information processing device according to claim 1, wherein
the extractor extracts the inducement destination candidate according to the behavioral characteristics of the user, by inputting data indicating changes along a time series in each of a plurality of behaviors associated with each of the series of pieces of the history data,
to a learned model established based on supervised learning using teacher data where information indicating the inducement destination candidate used by a user as a subject of the plurality of behaviors is associated with the data indicating the changes along the time series in each of the plurality of behaviors, as a correct label.

10. The information processing device according to claim 9, wherein
the extractor extracts an inducement destination candidate according to the behavioral characteristics of the user where predetermined characteristics are considered regarding relationship with a target user, by inputting data indicating changes along a time series in each of a plurality of behaviors associated with each of the series of pieces of the history data,
to the learned model that corresponds to the predetermined characteristic and is established based on supervised machine learning using teacher data where information indicating the inducement destination candidate used by the user is associated as a correct label with the data indicating the changes along the time series in each of the plurality of behaviors of the user exhibiting the predetermined characteristics regarding the relationship with the inducement destination candidate.

11. An information processing method executed by an information processing device, comprising:
associating each of a series of pieces of history data related to at least any of deposits and withdrawals of a user with any of a plurality of behaviors related to an economic activity of the user;
extracting an inducement destination candidate according to behavioral characteristics of the user based on changes along a time series of each of the plurality of behaviors; and
outputting information indicating the extracted inducement destination candidate to a predetermined output destination.

12. A non-transitory computer readable storage medium storing a program for causing a computer to execute:
associating each of a series of pieces of history data related to at least any of deposits and withdrawals of a user with any of a plurality of behaviors related to an economic activity of the user;
extracting an inducement destination candidate according to behavioral characteristics of the user based on changes along a time series of each of the plurality of behaviors; and
outputting information indicating the extracted inducement destination candidate to a predetermined output destination.
